(19) United States
(12) Patent Application Publication
(10) Pub. No.: US 2004/0141106 A1
(43) Pub. Date: Jul. 22, 2004

(54) [REFLECTIVE LIQUID CRYSTAL DISPLAY]

(76) Inventors: Ivan Yang-En Wu, Taipei (TW); Jian-Shen Yu, Hsinchu (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(21) Appl. No.: 10/604,269

(22) Filed: Jul. 8, 2003

(30) Foreign Application Priority Data
Jul. 8, 2002 (TW) 91115042

(51) Int. Cl. G02F 1/1335

(52) U.S. Cl. 349/69; 349/113

(57) ABSTRACT

A reflective liquid crystal display, having a liquid crystal display panel and a regional light source. The liquid crystal display panel has a plurality of pixels, and each of the pixels has a plurality of corresponding color blocks. The regional light source is directly incident on the liquid crystal display panel, such that the light generated thereby is impinging on a reflection layer of the liquid crystal display panel to cause reflection. The allocation of the regional light source includes scattered dots distributed over the color blocks corresponding to the liquid crystal display panel. Alternatively, the regional light source is allocated at an edge of each of the color blocks, or with an arrangement allowing the light to be incident uniformly.

### CROSS REFERENCE TO RELATED APPLICATIONS

This application claims the priority benefit of Taiwan application serial no. 91115042, filed Jul. 08, 2002.

### BACKGROUND OF INVENTION

1. Field of the Invention

The invention relates in general to a liquid crystal display (LCD), and more particularly, to a reflective liquid crystal display using a regional light source as a front light.

2. Related Art of the Invention

The liquid crystal display can be categorized into two major types, reflective type and backlight type. As the reflective liquid crystal display uses reflected light as the display light source, so that the power consumption is reduced and the weight is lighter, the backlight is not required. Recently, the reflective liquid crystal display has caused great attention in industry.

FIG. 1 shows the cross sectional view of a portion of a conventional reflective liquid crystal display.

As shown in FIG. 1, the conventional liquid crystal display comprises a liquid crystal display panel 10 and a front light 30. The liquid crystal display panel 10 includes a thin-film transistor substrate 20, a color filter 14, a polarizer 12 attached on the color filter 14, a reflection layer 18 formed on the thin-film transistor substrate 20, and a liquid crystal display layer 16 formed between the thin-film transistor substrate 20 and the color filter 14. The front light 30 includes a light-emitting source 22 and a prism set 24.

The prism set 24 of the front light 30 in the reflective liquid crystal display has several prisms to radiate the light beam 26 generated by the light-emitting source 22 into the liquid crystal display 10 uniformly. The light beam 26 transmitting through the polarizer 12, the color filter 14, and the liquid crystal layer 16 of the liquid crystal display panel 10 is reflected by the reflection layer 18 on the thin-film transistor substrate 20. The reflected light beam then travels through the liquid crystal layer 16, the color filter 14 and the polarizer 12 to emit and display the required color luminance.

As the conventional reflective liquid crystal display uses many prisms to uniformly radiate the light beam generated by the front light, the reflection of the prisms frequently causes leakage in the dark. Consequently, before the front light is switched off, the contrast of the reflective liquid crystal display is poor. In addition, the amount of prisms restricts the display from being developed lighter and thinner.

### SUMMARY OF INVENTION

The present invention provides a reflective liquid crystal display to resolve the problem caused by using prisms in the front light.

The present invention also provides a thinner and lighter reflective liquid crystal display by removing the prisms from the front light.

The present invention provides a reflective liquid crystal display, including a liquid crystal display panel and a regional light source. The liquid crystal display panel has a plurality of pixels corresponding to a plurality of color blocks. The regional light source emits a light onto the liquid crystal display panel. The light is then reflected by a reflection layer of the liquid crystal display panel. The regional light source includes a plurality of spot light sources scattered on the liquid crystal display panel between color blocks. The spot light sources may also be allocated to encircle each of the color blocks by being located on an edge thereof.

The present invention further provides a reflective liquid crystal display which comprises a liquid crystal display panel and a regional light source. The liquid crystal display panel has a plurality of pixels, and each of the pixels corresponds to a plurality of color blocks. The regional light source is attached to a polarizer of the liquid crystal display panel, such that a light generated thereby incident on the liquid crystal display panel is reflected by a reflection layer thereof. The regional light source includes a plurality of spot light sources scattered over the color blocks of the liquid crystal display panel, or at an edge of each color block.

The present invention uses the regional light source as the front light for the reflective liquid crystal display, so that the poor contrast caused by using many prisms in the conventional liquid crystal display is resolved.

As the prisms are removed from the front light, the reflective liquid crystal display can be made thinner and lighter.

The dimension of the regional light source used as the front light in the liquid crystal display can be adjusted during the fabrication process, such that the transmission rate of the regional light source is maintained at a certain magnitude.

The regional light source is in a form of uniformly distributed dots or a plurality of dots encircling each color block of the liquid crystal display panel, such that the light can be uniformly distributed to each color block.

### BRIEF DESCRIPTION OF DRAWINGS

These, as well as other features of the present invention, will become more apparent upon reference to the following drawings.

FIG. 1 shows the cross sectional view of a conventional reflective liquid crystal display panel.

FIG. 2 shows the cross sectional view of a liquid crystal display panel of a reflective liquid crystal display in one embodiment of the present invention.

FIG. 3 shows the cross sectional view of a liquid crystal display panel of a reflective liquid crystal display in another embodiment of the present invention.

FIG. 4 shows the allocation of a liquid crystal display with an organic light emitting diode as the light source in one embodiment of the present invention.

FIG. 5 shows the allocation of a liquid crystal display with another organic light emitting diode as the light source in one embodiment of the present invention.

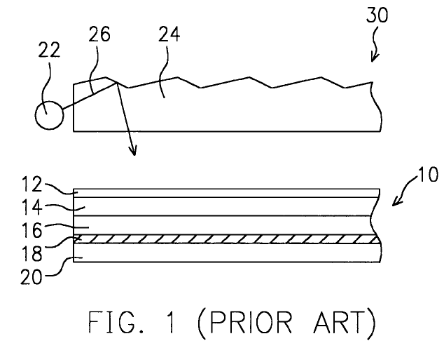

### DETAILED DESCRIPTION

### First Embodiment

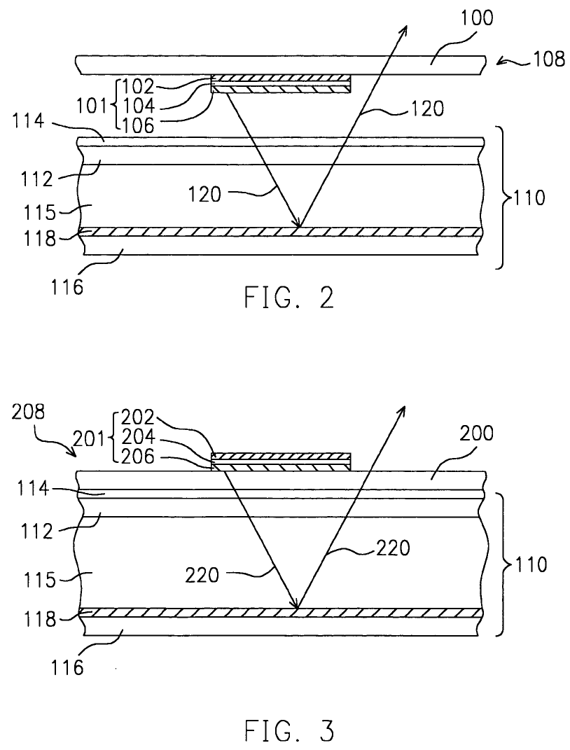

FIG. 2 shows a cross sectional view of a reflective liquid crystal display.

Referring to FIG. 2, the reflective liquid crystal display comprises a liquid crystal display panel 110 and a regional light source 108. In this embodiment, the regional light source 108 includes a light emitting diode such as an organic light emitting diode (OLED). The regional light source 108 emits a light radiating on the liquid crystal display panel 110 as a front light thereof.

The liquid crystal display panel 110 comprises a color filter 112, a polarizer 114, a liquid crystal layer 115, a thin-film transistor substrate 116 and a reflection layer 118. The liquid crystal layer 115 is located between the color filter 112 and the thin-film transistor substrate 116. The polarizer 114 is disposed on the color filter 112, and the reflection layer 118 is formed on the thin-film transistor substrate 116. The thin-film transistor substrate 110 includes devices such as thin-film transistors (not shown). The reflection layer 118 includes a conductive material with a high reflectivity and can be used as a reflective electrode. The color filter 112 has a plurality of color blocks (not shown) corresponding to the reflective electrodes on the thin-film transistor substrate 116. The polarizer 114 disposed on the color filter 112 is used to polarize the light generated by the regional light source 108 and reflected by the reflection layer 118. By controlling the electric field formed between the reflective electrode (that is, the reflection layer) of the thin-film transistor substrate 112 and the opposing electrode (not shown) of the color filter 112, various twisting angles of the liquid crystal can be obtained. Therefore, the light traveling through the liquid crystal layer 115 is twisted into a light 120 with the required color and displaying effect.

In this embodiment, the regional light source 108 is located on the liquid crystal display panel 110 to directly radiate a light thereon. The regional light source 108 includes a substrate 100 and a light-emitting structure 101. The substrate 100 includes a transparent material such as glass, while the light-emitting structure 101 includes an organic light emitting diode, for example. The light-emitting structure 101 is disposed on one side of the substrate 100 to face the liquid crystal display panel 110. The light-emitting structure 101 includes a cathode 102, a luminescent layer 104 and an anode 106. The luminescent layer 104 is sandwiched between the cathode 102 and the anode 106. The material for forming the cathode 102 includes metal with good conductivity such as silver and aluminum. The luminescent layer 104 is made of luminescent organic material. The anode includes a transparent conductive material such as indium oxide (ITO).

In this embodiment, the light-emitting structure 110 of the regional light source 108 is located at the side of the substrate 100 facing the liquid crystal display panel 110 as shown in FIG. 2. The light beam 120 generated by the luminescent layer 104 of the region light source 108 transmitting through the anode 106, the polarizer 114, the color filter 112 is reflected by the reflection layer 118. The liquid crystal layer 115 sandwiched between the thin-film transistor substrate 116 and the color filter 112 are twisted with various twisting angles according to the electric field applied thereto. Therefore, the reflected light beam 120 is twisted after traveling through the liquid crystal layer 115. After traveling through the color filter 112 and the polarizer 114, the light beam 120 emitted from the liquid crystal display panel 110 displays the required color and intensity.

In this embodiment, the reflective liquid crystal display resolves the leakage problem by avoiding using the prisms. Therefore, the contrast of the liquid crystal display before switching on the front light is improved. Further, as the prisms are removed from the front light, the display can be made thinner and lighter.

Second Embodiment

FIG. 3 shows the cross sectional view of a reflective liquid crystal display in another embodiment of the present invention.

As shown in FIG. 3, the regional light source 108 includes a substrate 200 and a light-emitting structure 201. The substrate 200 includes a transparent material such as glass. The light-emitting structure 201 includes a cathode 202, a luminescent layer 204 and an anode 206. The luminescence layer 204 is formed between the cathode 202 and the anode 206. The light-emitting structure 201 includes an organic light emitting diode, for example. The light-emitting structure 201 is located on the side of the substrate 200 distal to the liquid crystal display panel 110. Therefore, the regional light source 208 can be disposed on the polarizer 114 without resulting in a space between the regional light source 208 and the liquid crystal display panel 110.

In this embodiment, each device of the liquid crystal display panel 110 is the same as that described in the first embodiment.

This embodiment has the same advantage as that of the first embodiment. That is, in addition to the advantages of being lighter and thinner, the interface reflection is reduced since the substrate 200 of the regional light source 208 is directly mounted to the polarizer 114. In addition, as the regional light source 208 is directly attached to the polarizer 114, the air interface does not exist between the regional light source 208 and the polarizer 114. The polarizer 114 with lower quality can be used to save the material cost.

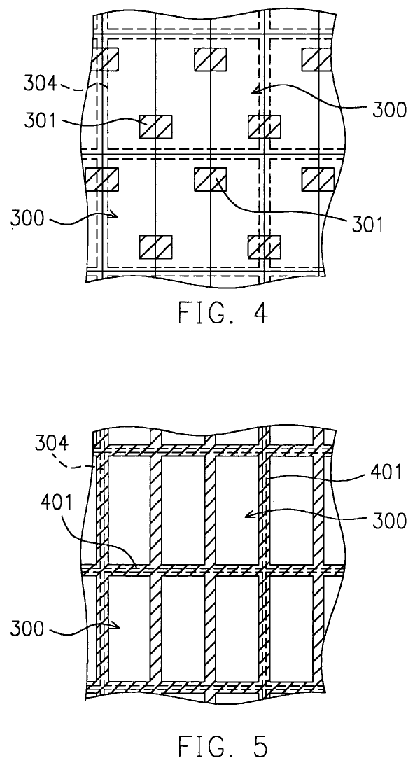

FIG. 4 shows a top view of a regional light source in the reflective liquid crystal display.

Referring to FIG. 4, the first and second embodiments of the present invention use a regional light source such as an organic light-emitting diode as the front light in the reflective liquid crystal display. The regional light source has a plurality of light-emitting structures 301 scattered between the color blocks 300 on the liquid crystal display panel (not shown). The liquid crystal display panel has a plurality of pixels 304, and each of the pixels 304 has a plurality of the color blocks 300. The light-emitting structures 301 can be uniformly distributed over the color blocks 300, or disposed across two of the color blocks 300. Therefore, the light source can be evenly distributed to each of the color block 300.

FIG. 5 shows another allocation of the regional light source according to the present invention.

Referring to FIG. 5, the organic light emitting diode can be used as the front light of the reflective liquid crystal display in the first and second embodiments. The light-emitting structures 401 are located at the edge of each color block 300. Consequently, each color block 300 is encircled by the light-emitting structures 401. The liquid crystal display panel has a plurality of pixels 304, and each of the pixels 304 corresponds to a plurality of the color blocks 300. The organic light emitting diode 402 can thus be evenly distributed to each of the color blocks 300.

The allocation of the regional light source according to the present invention allows the light to be evenly distributed to each color block of the liquid crystal display panel. Further, the dimension of the light-emitting diode can be properly adjusted during fabrication process, such that the transmissivity of the organic light-emitting diode can be well controlled.

It is appreciated that the allocation of the light-emitting structures is not limited to the above description. Any arrangement of the light-emitting structure allowing the light generated thereby to be evenly distributed on the liquid crystal display panel is within the scope of the present invention.

Accordingly, the present invention has the following advantages.

1. The present invention uses a regional light source as the front light to replace the prisms used in the conventional liquid crystal display panel, such that the contrast of the liquid crystal display before switching on the front light is improved.

2. The removal of the prisms allows the reflective liquid crystal display panel to be made thinner and lighter.

3. The regional light source is in a form of scatter dots or dots encircling each color block, such that light source is evenly distributed.

4. The transmissivity of the regional light source can be maintained to a desired range by adjusting the dimension thereof during the fabrication process.

5. The regional light source can be directly attached to the polarizer to reduce the interface reflection. The polarizer with lower quality can thus be used to reduce the material cost.

In this embodiment, the organic light-emitting diode is used as the regional light source as an example. It is appreciated that the present invention is not limited thereto. Other region light sources can also used as the front light of the reflective liquid crystal display.

Other embodiments of the invention will appear to those skilled in the art from consideration of the specification and practice of the invention disclosed herein. It is intended that the specification and examples be considered as exemplary only, with a true scope and spirit of the invention being indicated by the following claims.

1. A reflective liquid crystal display, comprising:
a liquid crystal display panel having a plurality of pixels, wherein each pixel has a plurality of color blocks; and
a regional light source over the liquid crystal display panel to radiate directly thereon.

2. The reflective liquid crystal display according to claim 1, wherein the regional light source comprises:
a substrate; and
a light-emitting structure on one side of the substrate.

3. The reflective liquid crystal display according to claim 2, wherein the light-emitting structure is disposed on the side of the liquid crystal display panel facing the liquid crystal display panel.

4. The reflective liquid crystal display according to claim 2, wherein the light-emitting structure is disposed on the side of the liquid crystal display panel distal to the liquid crystal display panel.

5. The reflective liquid crystal display according to claim 2, wherein the light-emitting structure includes an organic light emitting diode.

6. The reflective liquid crystal display according to claim 5, wherein the light-emitting structure further comprises:
a cathode;
an anode, under the cathode at the side facing the liquid crystal display panel; and
a luminescent layer, between the cathode and the anode.

7. The reflective liquid crystal display according to claim 2, wherein the light-emitting structure includes a plurality of spots scattered over each of the color blocks.

8. The reflective liquid crystal display according to claim 7, wherein the light-emitting structure is disposed across at least two of the color blocks.

9. The reflective liquid crystal display according to claim 1, wherein the regional light source is located at an edge of each of the color blocks.

10. The reflective liquid crystal display according to claim 1, wherein the liquid crystal display panel comprises:
a color filter;
a polarizer on the color filter;
a thin-film transistor substrate without direct contact to the color filter;
a reflection layer, formed on the thin-film transistor substrate; and
a liquid crystal layer, filled between the color filter and the thin-film transistor substrate.

11. The reflective liquid crystal display according to claim 10, wherein the regional light source is directly mounted to the polarizer.

12. A reflective liquid crystal display, comprising:
a liquid crystal display panel, having a plurality of pixels, and each of the pixels having a plurality of color blocks; and
an organic light emitting diode, disposed over the liquid crystal display panel to radiate thereon directly.

13. The reflective liquid crystal display according to claim 12, wherein the light emitting diode comprises:
a substrate; and
a light-emitting diode on one side of the substrate.

14. The reflective liquid crystal display according to claim 13, wherein the light-emitting diode is disposed on the side of the liquid crystal display panel facing the liquid crystal display panel.

15. The reflective liquid crystal display according to claim 13, wherein the light-emitting diode is disposed on the side of the liquid crystal display panel distal to the liquid crystal display panel.

16. The reflective liquid crystal display according to claim 13, wherein the light-emitting diode further comprises:
a cathode;
an anode, under the cathode at the side facing the liquid crystal display panel; and
a luminescent layer, between the cathode and the anode.

17. The reflective liquid crystal display according to claim 13, wherein the organic light-emitting diode includes a plurality of spots scattered over each of the color blocks.

18. The reflective liquid crystal display according to claim 17, wherein the organic light-emitting diode is disposed across at least two of the color blocks.

19. The reflective liquid crystal display according to claim 12, wherein the organic light-emitting diode is located at an edge of each of the color blocks.

20. The reflective liquid crystal display according to claim 12, wherein the liquid crystal display panel comprises:
a color filter;
a polarizer on the color filter;
a thin-film transistor substrate without direct contact to the color filter;
a reflection layer, formed on the thin-film transistor substrate; and
a liquid crystal layer, filled between the color filter and the thin-film transistor substrate.

21. The reflective liquid crystal display according to claim 20, wherein the organic light-emitting diode is directly mounted to the polarizer.
